(19) United States
(12) Patent Application Publication
(10) Pub. No.: US 2026/0221548 A1
(43) Pub. Date: Jul. 30, 2026

(54) BATTERY

(71) Applicant: TOYOTA JIDOSHA KABUSHIKI KAISHA, Toyota-shi (JP)

(72) Inventor: Sadao FUJISAKI, Hadano-shi (JP)

(73) Assignee: TOYOTA JIDOSHA KABUSHIKI KAISHA, Toyota-shi (JP)

(21) Appl. No.: 19/331,317

(22) Filed: Sep. 17, 2025

(30) Foreign Application Priority Data
Jan. 28, 2025 (JP) 2025-012365

(51) Int. Cl. H01M 50/119; H01M 50/103; H01M 50/15; H01M 50/264

(52) U.S. Cl. CPC H01M 50/119; H01M 50/103; H01M 50/15; H01M 50/264

(57) ABSTRACT

A battery includes: an electrode assembly; and a metal exterior case having a rectangular parallelepiped shape and housing the electrode assembly. The metal exterior case includes a first main surface and a second main surface, each extending in a direction intersecting a thickness direction. Either or both of the main surfaces include a variable structure configured to allow the main surface to variably assume one of the following shapes in accordance with a volume change of the electrode assembly: a recessed shape in which the main surface is recessed inward in the thickness direction, a protruding shape in which the main surface protrudes outward in the thickness direction, and an intermediate shape between the recessed shape and the protruding shape.

### CROSS-REFERENCE TO RELATED APPLICATION

This application claims priority to Japanese Patent Application No. 2025-012365 filed on Jan. 28, 2025. The disclosure of the above-identified application, including the specification, drawings, and claims, is incorporated by reference herein in its entirety.

### BACKGROUND

### 1. Technical Field

The present disclosure relates to batteries.

### 2. Description of Related Art

In recent years, demand for secondary batteries has been increasing, and in addition to secondary batteries that include an electrolyte solution, development of solid-state batteries using solid electrolytes has been actively pursued. An all-solid-state battery, which is an example of a solid-state battery, is a battery that includes a solid electrolyte layer in place of a liquid electrolyte. Since it does not use a flammable organic solvent, the safety system can be simplified, resulting in reduced manufacturing cost and improved productivity.

There is known a battery exterior case configured to suppress deformation caused by an increase in internal pressure of the battery. In this battery exterior case, an external can has a recessed portion recessed inward in the thickness direction of the external can, and a reinforcing member is disposed in the recessed portion (see Japanese Unexamined Patent Application Publication No. 2017-22057 (JP 2017-22057 A)).

### SUMMARY

In secondary batteries, for example, in batteries accommodating electrode assemblies that undergo relatively large volume changes during charging and discharging, it may be difficult to suppress deformation of the exterior case.

An object of one embodiment of the present disclosure is to provide a battery with high reliability.

Means for achieving the above object include the following aspects.
(1) A battery including: an electrode assembly; and a metal exterior case having a rectangular parallelepiped shape and housing the electrode assembly, wherein: the metal exterior case includes a first main surface and a second main surface, each extending in a direction intersecting a thickness direction; and either or both of the main surfaces include a variable structure configured to allow the main surface to variably assume one of the following shapes in accordance with a volume change of the electrode assembly: a recessed shape in which the main surface is recessed inward in the thickness direction, a protruding shape in which the main surface protrudes outward in the thickness direction, and an intermediate shape between the recessed shape and the protruding shape.
(2) The battery according to (1), wherein the variable structure is a structure configured to allow the main surface to reversibly switch between the recessed shape and the protruding shape.
(3) The battery according to (1) or (2), wherein the variable structure includes a thickened structure portion, the thickened structure portion including a wall portion provided along each of four sides surrounding the main surface, and a corner portion connected to the wall portion.
(4) The battery according to (3), wherein the thickened structure portion has a curved shape.
(5) The battery according to any one of (1) to (4), wherein a stack is constituted by a plurality of the batteries arranged such that the main surfaces face each other; and the stack includes a structure configured to restrain the batteries under pressure applied in the thickness direction.

One embodiment of the present disclosure provides a battery with high reliability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing an example of a battery;

FIG. 2 is a schematic diagram illustrating deformation of a main surface when the battery is viewed from the side;

FIG. 3 is a schematic enlarged view of a thickened structure portion, illustrating the shape thereof;

FIG. 4 is an explanatory diagram illustrating an example of a method for manufacturing a battery having a metal exterior case formed by an inner lid and an outer lid;

FIG. 5 is a schematic plan view illustrating the configuration of a stack; and

FIG. 6 is a schematic side view of the stack as viewed from the thickness direction X.

### DETAILED DESCRIPTION OF EMBODIMENTS

In the present disclosure, numerical ranges expressed using “to” are intended to include the minimum and maximum values indicated before and after “to,” respectively.

In the present disclosure, when numerical ranges are presented progressively from broader to narrower ranges, the upper or lower limit of one numerical range may be replaced with the upper or lower limit of another. In the numerical ranges described in the present disclosure, the upper or lower limit of one numerical range may be replaced with a value indicated in the examples.
In the present disclosure, the term “step” includes not only independent steps but also steps that may not be clearly distinguishable from other steps, as long as the intended purpose of the step is achieved.
In the present disclosure, a combination of two or more preferred forms is considered a more preferred form.
In the present disclosure, when an embodiment is described with reference to the drawings, the configuration of the embodiment is not limited to that shown in the drawings. The sizes of components in the drawings are conceptual, and the relative sizes of components are not limited thereto.

### Battery

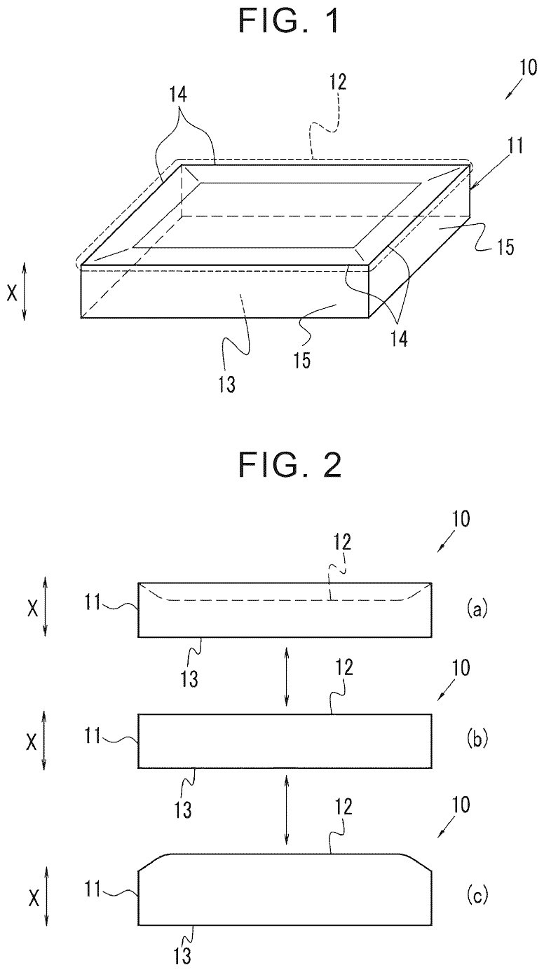

Hereinafter, a battery according to one embodiment of the present disclosure will be described with reference to FIGS. 1 to 6.

A battery according to one embodiment of the present disclosure includes an electrode assembly, and a metal exterior case having a rectangular parallelepiped shape and housing the electrode assembly. The metal exterior case includes two main surfaces, namely a first main surface and a second main surface, each extending in a direction intersecting a thickness direction of the battery. Either or both of the main surfaces include a variable structure configured to allow the main surface to variably assume one of the following shapes in accordance with a volume change of the electrode assembly: a recessed shape in which the main surface is recessed inward in the thickness direction, a protruding shape in which the main surface protrudes outward in the thickness direction, and an intermediate shape between the recessed shape and the protruding shape.

The circumstances that led to the embodiment of the present disclosure are described. When the electrode assembly undergoes relatively large volume deformation due to expansion and contraction during charging and discharging of the battery, repeated loads may be applied to the exterior case, making it difficult to suppress deformation of the exterior case. Accordingly, electrode assemblies made of materials with reduced volume deformation have been used. In some cases, such as with all-solid-state batteries, a constant load is applied to the electrode assembly, and the exterior case is designed to deform in accordance with the expansion and contraction of the electrode assembly.

The inventors focused on deformation of the metal exterior case with the aim of identifying a structure for the exterior case capable of appropriately accommodating even an electrode assembly that undergoes a relatively large volume change, such as a volume change exceeding 10%, during charging and discharging. The inventors have found that providing the exterior case with a variable structure that allows the main surface of the exterior case to variably assume one of the following shapes enables the exterior case to accommodate even relatively large volume changes of the electrode assembly without damage etc. The shapes include: a recessed shape in which the main surface is recessed inward in the thickness direction (i.e., a direction toward the interior of the battery), a protruding shape in which the main surface protrudes outward in the thickness direction (i.e., a direction toward the exterior of the battery), and an intermediate shape between the recessed and protruding shapes.

As shown in FIG. 1, a battery 10 according to one embodiment of the present disclosure includes a metal exterior case 11 having a rectangular parallelepiped shape. The metal exterior case 11 houses an electrode assembly (not shown). The metal exterior case 11 has a first main surface 12 and a second main surface 13. The main surfaces 12, 13 are, for example, surfaces each extending in a direction perpendicularly intersecting a thickness direction X of the metal exterior case 11. The thickness direction X corresponds to the stacking direction of the electrode assembly.

As shown in FIG. 2, the main surface 12 includes a variable structure and is configured to deform in accordance with expansion and contraction of the electrode assembly. The main surface 12 of the metal exterior case 11 includes a variable structure configured to allow the main surface 12 to variably assume one of the following shapes when the battery 10 is viewed from the side: a recessed shape (a) in which the main surface 12 is recessed inward in the thickness direction X, a protruding shape (c) in which the main surface 12 protrudes outward in the thickness direction X, and an intermediate shape (b) between the recessed shape (a) and the protruding shape (c).

As used herein, the phrase “variably assume” means that the shape is variable. For example, the main surface 12 may initially be in the recessed shape (a), and may change to the protruding shape (c) via the planar intermediate shape (b) as the electrode assembly expands. Subsequently, as the electrode assembly contracts, the main surface 12 may return to the recessed shape (a) via the planar intermediate shape (b) from the protruding shape (c). The main surface 12 may repeatedly undergo such deformation.

The “protruding shape” assumed by the main surface 12 includes a shape in which part or all of the main surface 12 protrudes outward in the thickness direction X of the metal exterior case 11. The “recessed shape” assumed by the main surface 12 includes a shape in which part or all of the main surface 12 is recessed inward in the thickness direction X of the metal exterior case 11. The “intermediate shape” refers to a shape assumed by the main surface 12 that is other than the protruding shape and the recessed shape.

In FIG. 2, the intermediate shape (b) is a shape in which the main surface 12 is flat. However, the intermediate shape is not limited to the flat state, and may alternatively be a shape in which the main surface 12 is recessed to some extent, namely a shape closer to the recessed shape (a), or a shape closer to the protruding shape (c). In the present disclosure, at least one of the main surfaces may be in a shape in which the main surface 12 is protruding to some extent, namely a shape closer to the recessed shape or the protruding shape.

In the present disclosure, either or both of the main surfaces may include a variable structure that may allow the main surface to reversibly deform from one of the recessed shape and the protruding shape (e.g., the recessed shape (a)) to the other (e.g., the protruding shape (c)). Accordingly, the metal exterior case 11 accommodates expansion of the electrode assembly in the thickness direction X, namely an increase in length in the thickness direction X, with the main surface 12 deforming from the recessed shape (a) to the protruding shape (c). The metal exterior case 11 also accommodates contraction of the electrode assembly in the thickness direction X, namely a decrease in length in the thickness direction X, with the main surface 12 deforming from the protruding shape (C) to the recessed shape (a). With regard to deformation between the recessed shape (a) and the protruding shape (c), it is preferable that the recessed shape (a) be inverted into the protruding shape (c). Compared to a configuration in which the metal exterior case 11 does not include a variable structure and the main surface 12 does not deform, the metal external case 11 whose main surface 12 is configured to deform as described above can accommodate expansion of the electrode assembly in the thickness direction X up to a length equivalent to twice the depth of the recessed shape (a) in the thickness direction X.

It is preferable that each of the two main surfaces of the metal exterior case 11, namely each of the first main surface 12 and the second other main surface 13, is configured to variably assume one of the following shapes: the recessed shape (a) in which the main surface is recessed inward in the thickness direction X of the battery (i.e., a direction toward the interior of the battery), the protruding shape (c) in which the main surface protrudes outward in the thickness direction X (i.e., a direction toward the exterior of the battery), and the intermediate shape (b) between the recessed shape (a) and the protruding shape (c). In this case, compared to a configuration in which one of the main surfaces, namely the main surface 12, is deformable, the metal exterior case 11 can accommodate expansion of the electrode assembly in the thickness direction X up to twice the length of the electrode assembly in the thickness direction X as both main surfaces 12, 13 deform. That is, compared to a configuration in which the metal exterior case 11 is configured to retain a rectangular shape and configured not to allow the main surface 12 to deform, the metal exterior case 11 configured to allow both main surfaces 12, 13 to deform as described above can accommodate expansion of the electrode assembly in the thickness direction X up to a length equivalent to four times the depth of the recessed shape (a) in the thickness direction X.

The variable structure of the main surface is preferably a structure configured to allow the main surface to reversibly switch between the recessed shape and the protruding shape. As described above, it is preferable that one or both of the main surfaces have a variable structure configured to allow the main surface to switch from one of the recessed shape and the protruding shape to the other, and vice versa.

The main surface 12 may continuously change its shape in accordance with volume changes of the electrode assembly. For example, the main surface 12 may gradually deform from the recessed shape (a) in which the main surface is recessed inward in the thickness direction X to the protruding shape (c) in which the main surface protrudes outward in the thickness direction X, as the electrode assembly gradually expands. The main surface 12 may also gradually deform from the protruding shape (c) to the recessed shape (a) as the expanded electrode assembly gradually contracts. During deformation from the recessed shape (a) to the protruding shape (c), or vice versa, an intermediate shape other than the recessed shape (a) and the protruding shape (c) may be formed between the recessed shape (a) and the protruding shape (c). For example, the intermediate shape may be a shape in which four sides 14 and the main surface 12 together form a flat surface.

From the viewpoint of energy density of the battery 10, the shape of the metal exterior case 11, including the shape of the variable structure, may be determined according to the type of the electrode assembly. Preferably, the shape of the metal exterior case 11 is determined according to the amount of expansion of the electrode assembly. In the expansion of the electrode assembly, the depth of the recessed shape (a) in the thickness direction X or the height of the protruding shape (c) in the thickness direction X may be set to approximately 25% of the expansion length in the thickness direction X, that is, the amount of expansion in the thickness direction X.

As described above, the metal exterior case 11 is capable of accommodating volume changes of the electrode assembly. That is, the battery 10 is capable of accommodating greater volume changes of the electrode assembly than conventional batteries, thereby allowing for greater flexibility in the selection of materials for the electrode assembly. Furthermore, even when the electrode assembly undergoes volume changes, damage etc. to the metal exterior case 11 can be suppressed, thereby providing a battery with high reliability.

Since the battery 10 has a structure in which the metal exterior case 11 itself deforms, cushioning members such as springs, which would otherwise be used inside the metal exterior case 11 when such a structure is not provided, can be omitted. Such cushioning members are used in types of batteries in which a restraining pressure is applied to the electrode assembly in the thickness direction X. In the battery 10, the metal exterior case 11 can deform so as to closely conform to the electrode assembly housed therein. Therefore, by externally applying a restraining pressure to the metal exterior case 11, a corresponding restraining pressure can also be applied to the electrode assembly. Accordingly, cushioning members such as springs are not provided inside the metal exterior case 11, which makes it possible to increase the energy density of the battery.

The main surface 12 is defined by four sides surrounding the main surface 12. These sides include the four sides 14. Each side 14 is a portion where the main surface 12 is connected to a corresponding one of side surfaces 15. The sides 14 preferably do not deform when the main surface 12 deforms. The main surface 12 preferably deforms with the four sides 14 serving as support portions. The same applies to the main surface 13.

The variable structure of the main surface preferably includes a thickened structure portion. Preferably, the thickened structure portion is provided on each of the four sides surrounding the main surface, and allows the main surface to variably assume different shapes. As used herein, the term “thickened structure portion” refers to a structure having extensibility, contractibility, variability, etc. that allow for changes in the shape of the main surface. The thickened structure portion has a structure configured to undergo elongation and contraction due to the material properties of the metal exterior case, thereby allowing the shape of the main surface to change without causing damage etc. to the metal exterior case.

From the viewpoint of ensuring stable deformation of the main surface, the thickened structure portion is preferably provided around the main surface, and more preferably provided along the periphery of the main surface. Preferably, the thickened structure portion is a movable portion disposed along the four sides surrounding the main surface, and is a structure including wall portions capable of elongating and contracting and corner portions each connected to a corresponding one of the wall portions. More preferably, the thickened structure portion includes wall portions each provided along a corresponding one of the four sides surrounding the main surface, and corner portions each connected to a corresponding one of the wall portions.

The thickened structure portion is preferably part of the metal exterior case, and may be a structure formed by molding the metal exterior case. The structure of the thickened structure portion preferably has flexibility, elasticity, or the like for absorbing or dispersing shape changes of the main surface that occur in the thickness direction. When the main surface deforms in accordance with volume changes of the electrode assembly, the thickened structure portion disperses stress, thereby enabling stable operation of the variable structure. For example, the thickened structure portion may be provided along the four sides surrounding the main surface and may include wall portions and corner portions, thereby allowing the main surface to variably assume a recessed shape, a protruding shape, or an intermediate shape therebetween.

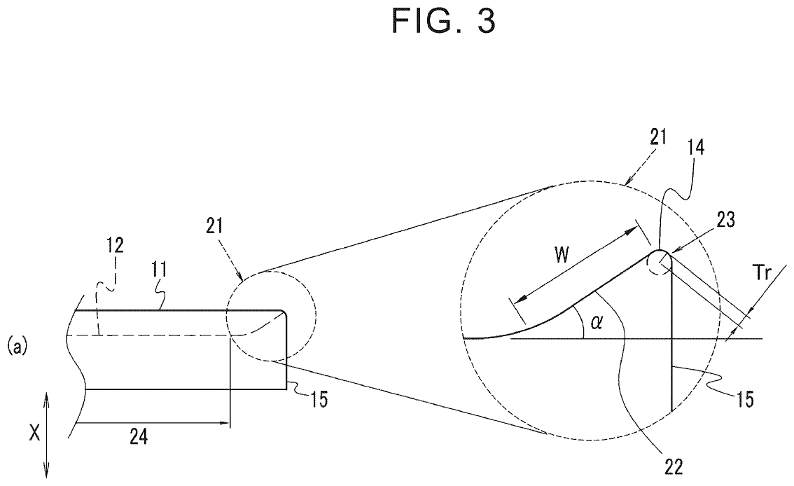

As shown in FIG. 3, a thickened structure portion 21 is provided on one of the four sides that surround the main surface 12, namely the side 14. FIG. 3 illustrates the shape of the thickened structure portion 21 when viewed from the side of the battery. The main surface 12 includes the thickened structure portion 21 and a flat portion 24 that is a region of the main surface 12 other than the thickened structure portion 21.

The thickened structure portion 21 includes a wall portion 22 and a corner portion 23. The corner portion 23 forms the side 14 of the main surface 12. The corner portion 23 is a bent portion where the main surface 12 and the side surface 15 are connected. The wall portion 22 is located between the corner portion 23 and the flat portion 24 on the main surface 12. The wall portion 22 is connected to the corner portion 23 and the flat portion 24.

The thickened structure portion 21 is formed on each of the four sides surrounding the main surface 12. The wall portions 22 and corner portions 23 included in the thickened structure portion 21 are preferably formed continuously and integrally so as to surround the main surface 12. The thickened structure portion 21 allows the main surface 12 to deform efficiently without damage etc., thereby improving the reliability of the battery.

The thickened structure portion 21 preferably has a curved shape. The curved shape is preferably formed at the corner portion 23, around the wall portion 22, or both. The curved shape at the corner portion 23 may be an R-shaped curve formed at a bend where the main surface 12 is connected to the side surface 15. The curved shape around the wall portion 22 may be an R-shaped curve formed at a connection portion between the wall portion 22 and the corner portion 23, a connection portion between the wall portion 22 and the flat portion 24, or both. In the metal exterior case 11, the curved shape of the thickened structure portion 21 is preferably a shape in which the parts of the thickened structure portion 21 are smoothly and continuously connected, and more preferably a shape in which all parts of the main surface 12, including the thickened structure portion 21 and the flat portion 24, are smoothly and continuously connected.

The curved shape at the corner portion 23, that is, the curved shape formed at the bend where the main surface 12 and the side surface 15 are connected, is preferably an R-shaped curve. From the viewpoint of suppressing stress concentration caused by deformation of the main surface 12 and improving the reliability of the battery 10, it is preferable that the R-dimension Tr (mm) at the bend where the main surface 12 and the side surface 15 are connected satisfies Tr>Tp, where Tp (mm) is the thickness of the material forming the metal exterior case 11. More preferably, Tr≥1.5×Tp. For example, when the R-dimension Tr is 0.5 mm, the material thickness Tp is set to 0.3 mm. This configuration can improve workability, enhance fatigue strength of the material, and reduce springback. From the viewpoint of allowing the main surface 12 to deform efficiently without damage etc. and improving the reliability of the battery, it is preferable that the R-dimension at at least one of the corners where adjacent corner portions 23 are connected (i.e., at least one of the four corners of the main surface) be greater than the R-dimension at the corner portions 23. When the R-dimension Tr at the corner portion 23 is 0.5 mm, the R-dimension at the corner (i.e., where adjacent corner portions 23 are connected) is set to, for example, 1.2 mm.

The portion of the main surface 12 other than the thickened structure portion 21 is defined as the flat portion 24. The flat portion 24 may be flat. The wall portion 22 is a portion that is continuous with the corner portion 23 and the flat portion 24. Preferably, the wall portion 22 has a shape that is smoothly continuous with the corner portion 23 and the flat portion 24. The wall portion 22 may be flat, or may be provided with a pattern etc. or have a bellows shape so as to facilitate deformation of the main surface 12.

From the viewpoint of suitably forming the thickened structure portion 21, the metal exterior case 11 is preferably made of a metal having an appropriate elongation percentage. The length W of the wall portion 22 in the width direction can be adjusted according to the bending angle α between the flat portion 24 and the wall portion 22. In order for the material forming the metal exterior case 11 to undergo sufficient plastic deformation, reduce springback after processing, and allow the main surface 12 to appropriately deform in response to volume changes of the electrode assembly, the maximum bending angle α is preferably determined based on the elongation percentage ε of the material forming the metal exterior case 11.

For example, when the elongation percentage ε (%) of the material is 15%, the maximum bending angle α is preferably set to less than 30°. In this case, as shown in FIG. 3, a right triangle is considered that includes the hypotenuse of the length W formed by extending the main surface 12 at an angle α of 30° and a line segment formed by extending the main surface 12 at an angle α of 0°. When the reference length of the remaining side of the triangle is set to 1, the reference length of the line segment becomes √3, and the reference length W of the hypotenuse becomes 2. When the main surface 12 is extended so as to be raised at an angle α of 30°, the resulting extra length becomes (2 −√3)≈0.3. Therefore, an allowance of 0.3 should be provided in the reference length W of the hypotenuse. That is, an allowance of 15% of the length W should be provided. In other words, when the elongation percentage ε of the material is 15%, the angle α is preferably less than 30°. Therefore, when a concave shape or the like is formed by bending at the angle α, it is preferable that the elongation percentage ε (%) of the material be greater than the ratio of the length obtained at α=30° to the length obtained at α=0° (i.e., the allowance (%) of the length W).

Similarly, in the case where the angle α is 45°, a right isosceles triangle is considered that includes the hypotenuse of the length W formed by extending the main surface 12 at an angle α of 45° and a line segment formed by extending the main surface 12 at an angle α of 0°. In this case, when the reference lengths of the line segment and the remaining side of the triangle are both set to 1, the reference length W of the hypotenuse becomes √2. When the main surface 12 is extended so as to be raised at an angle α of 45°, the resulting extra length becomes (√2−1)≈0.4. Therefore, an allowance of 0.4 should be provided in the reference length W of the hypotenuse. That is, an allowance of 28% of the length W should be provided. It is preferable that the elongation percentage ε (%) of the material be greater than the ratio (%) of the length obtained at α=45° to the length obtained at α=0°, that is, greater than 28%.

From the viewpoint of enabling the shape of the metal exterior case 11 to appropriately deform in response to volume changes of the electrode assembly and thereby ensuring high reliability of the battery 10, the material forming the metal exterior case 11 is preferably a metal plate having a thickness in the range of 0.1 mm to 1.0 mm, and more preferably in the range of 0.2 mm to 0.3 mm. The shape of the thickened structure portion 21, including the thickness of the material constituting the metal exterior case 11, the bending angle α, and the length of the wall portion 22 in the width direction, may be determined in accordance with the volume change of the electrode assembly.

The entire metal exterior case 11 may be formed from a single metal plate. In other words, the entire metal exterior case 11 may have a uniform thickness. The side surface 15 of the metal exterior case 11 may deform in accordance with expansion and contraction of the electrode assembly, and the above thickness allows the side surface 15 to deform without damage etc. When a thinner metal plate than those used in conventional battery cases is used for the battery exterior case, it is preferable to form the battery 10 by adopting a nested structure for the metal exterior case 11 and sealing its periphery with a resin.

### Method for Manufacturing Battery

A preferred method for manufacturing the battery 10 using the metal exterior case 11 includes: a step of forming an inner lid and an outer lid from a metal plate; a step of placing an electrode assembly in the inner lid; a step of assembling the outer lid with the inner lid in which the electrode assembly is placed; and a step of sealing the inner lid and the outer lid with a resin (sealing step). The metal exterior case 11 is formed by the inner lid and the outer lid.

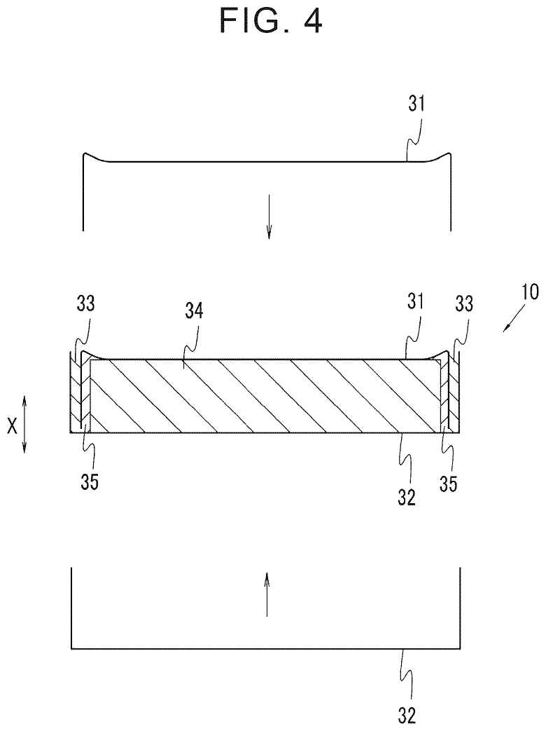

FIG. 4 is an explanatory diagram illustrating an example of a method for manufacturing a battery having a metal exterior case formed by an inner lid and an outer lid. As shown in FIG. 4, the battery 10 includes an electrode assembly 34 housed in the metal exterior case 11 having an inner lid 31 and an outer lid 32, and a resin 33 seals the assembled inner and outer lids 31, 32. Accordingly, welding etc. between the inner lid 31 and the outer lid 32 can be omitted, enabling the metal exterior case 11 to be formed from a thinner metal material than those used in conventional battery cases. By using a thinner metal plate than those used in conventional battery cases, the metal exterior case 11 can undergo uniform elongation, have a high elongation percentage, and maintain high durability without cracking, fracturing, etc. during elongation or contraction.

The forming method for the inner lid 31 and the outer lid 32 is not particularly limited. However, from the viewpoint of appropriately forming the shape of the main surface 12 including the thickened structure portion 21 or the main surface 13, it is preferable to form the inner lid 31 and the outer lid 32 by press forming.

The sealing with the resin 33 may be performed along the entire periphery of the inner lid 31 and the outer lid 32. Alternatively, when an electrode tab or the like is provided on the electrode assembly, the inner lid 31 and the outer lid 32 may be sealed with the electrode tab protruding from the metal exterior case 11. The metal exterior case 11 serves as a primary case that houses the electrode assembly 34. When the entire periphery of the inner lid 31 and the outer lid 32 is sealed, a material having an insulating function may be used for the sealing so that the inner lid 31 and the outer lid 32 can serve as terminals of the battery 10. For example, depending on the stacked state of the electrode assembly, the main surface 12 of the inner lid 31 may serve as the negative terminal, and the main surface 13 of the outer lid 32 may serve as the positive terminal. Alternatively, the main surface 12 of the inner lid 31 may serve as the positive terminal, and the main surface 13 of the outer lid 32 as the negative terminal.

The electrode assembly 34 included in the battery 10 may have a monopolar structure or a bipolar structure. As shown in FIG. 4, the battery 10 may include a resin member 35 that is a component for insulating between the electrode assembly 34 and the metal exterior case 11.

### Applications of Battery

Since the metal exterior case is capable of accommodating the volume changes of the electrode assembly housed therein, the battery is preferably a battery that tends to undergo expansion and contraction during charging and discharging, particularly a solid-state battery used under restraint in the thickness direction X. A solid-state battery may be a secondary battery such as a lithium-ion battery. Preferred examples include semi-solid batteries having a gel layer containing an electrolyte solution and a polymer between the electrode and the solid electrolyte, and all-solid-state batteries using a solid electrolyte as the electrolyte. Among these, all-solid-state batteries are more preferable because they can provide more stable battery performance.

The electrode assembly may be a conventionally known electrode assembly used in solid-state batteries. In order to achieve more stable battery performance, the electrode assembly is preferably an electrode assembly that undergoes a relatively large volume change during charging and discharging. Examples include electrode assemblies using silicon (Si)-based anode materials, sulfur (S)-based cathode materials, lithium (Li) metal anodes, high-nickel materials, alloy anodes, sulfide-based solid electrolytes, and oxide-based solid electrolytes.

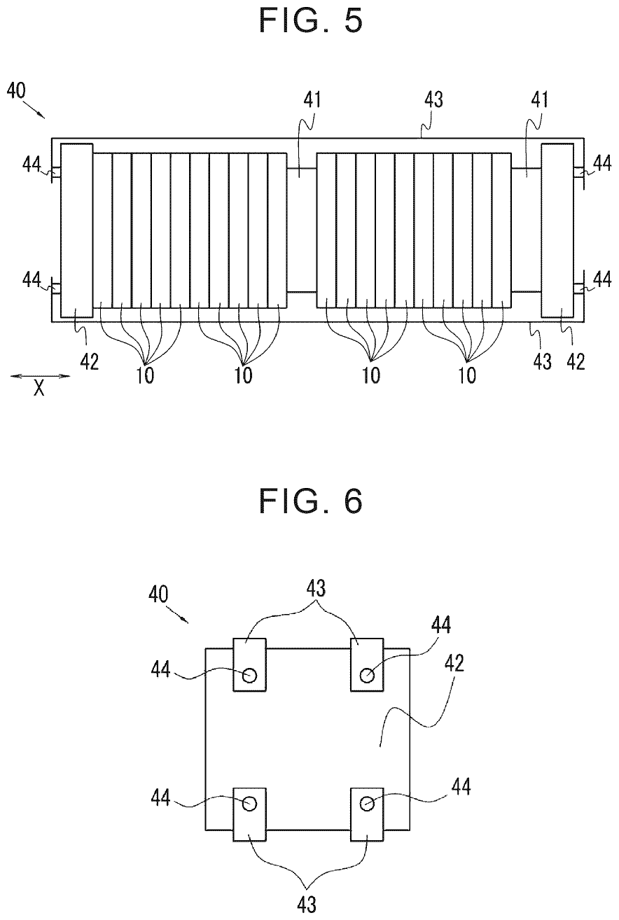

In order to achieve more stable battery performance, it is preferable to form a stack by arranging a plurality of batteries such that their main surfaces, including the main surfaces 12, 13, face each other, as shown in, for example, FIG. 5. The stack preferably includes a structure configured to restrain a plurality of batteries 10 under pressure applied in the thickness direction X. The stack can be used as a battery pack.

As shown in FIG. 5, a stack 40 includes a plurality of batteries 10, springs 41, end plates 42, and restraining bands 43. The batteries 10 are stacked with their main surfaces in contact with each other to form stacked bodies, the springs 41 are disposed between the stacked bodies, and a pair of end plates 42 is disposed at both ends in the thickness direction X. The batteries 10 are restrained and fixed in a pressurized state by the restraining bands 43. As shown in FIG. 6, the restraining bands 43 are secured to the end plates 42 by fasteners 44. The fasteners 44 are specifically rivets, bolts, or the like.

The restraining bands may be made of metal. Depending on the type of battery, the expansion of the battery may be absorbed by the elongation of the restraining band etc. In such a case, a disc spring serving as an absorption structure may be omitted. When the electrode assembly 34 has a monopolar structure, a sheet material or the like may be interposed between adjacent batteries 10 to ensure insulation, reduce the possibility of thermal propagation, and absorb expansion.

The application of the stack 40 is not particularly limited. Typical applications include power sources for vehicles, electronic devices, and energy storage systems. The stack 40 can be used as a high-capacity battery module that includes a plurality of batteries. Among these, the preferred application of the battery of the present disclosure is a power source for vehicles. Examples of such vehicles include electric four-wheel vehicles, electric two-wheel vehicles, gasoline vehicles, and diesel vehicles. Examples of electric four-wheel vehicles include battery electric vehicles (BEVs), plug-in hybrid electric vehicles (PHEVs), and hybrid electric vehicles (HEVs). Examples of electric two-wheel vehicles include electric motorcycles and electric assist bicycles.

What is claimed is:

1. A battery comprising:
an electrode assembly; and
a metal exterior case having a rectangular parallelepiped shape and housing the electrode assembly, wherein:
the metal exterior case includes a first main surface and a second main surface, each extending in a direction intersecting a thickness direction; and
either or both of the main surfaces include a variable structure configured to allow the main surface to variably assume one of the following shapes in accordance with a volume change of the electrode assembly: a recessed shape in which the main surface is recessed inward in the thickness direction, a protruding shape in which the main surface protrudes outward in the thickness direction, and an intermediate shape between the recessed shape and the protruding shape.

2. The battery according to claim 1, wherein the variable structure is a structure configured to allow the main surface to reversibly switch between the recessed shape and the protruding shape.

3. The battery according to claim 1, wherein the variable structure includes a thickened structure portion, the thickened structure portion including a wall portion provided along each of four sides surrounding the main surface, and a corner portion connected to the wall portion.

4. The battery according to claim 3, wherein the thickened structure portion has a curved shape.

5. The battery according to claim 1, wherein:
a stack is constituted by a plurality of the batteries arranged such that the main surfaces face each other; and
the stack includes a structure configured to restrain the batteries under pressure applied in the thickness direction.
